(19) United States
(12) Patent Application Publication
(10) Pub. No.: US 2010/0257010 A1
(43) Pub. Date: Oct. 7, 2010

(54) MANAGING A SERVICE ORIENTED ARCHITECTURE LIFECYCLE

(75) Inventors: Abdul Allam, Raleigh, NC (US); Kishore Channabasavaiah, Palatine, IL (US); Eric G. Dulin, McKinney, TX (US); Stephen C. Kendrick, Fairfax, VA (US); Subhash Kothuru, Pittsfield, MI (US); Sri Ramanathan, Lutz, FL (US); Matthew B. Trevathan, Kennesaw, GA (US); Raghu Varadan, San Francisco, CA (US); Nevenko Zunic, Hopewell Junction, NY (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/419,431

(22) Filed: Apr. 7, 2009

(51) Int. Cl. G06Q 10/00

(52) U.S. Cl. 705/8

(57) ABSTRACT

An invention that manages a service oriented architecture (SOA) lifecycle is provided. In one embodiment, there is a lifecycle management tool, including an identification component configured to identify a set of business objectives, evaluate a need for a SOA service solution based on the set of business objectives, and identify a set of candidate SOA shared services of the SOA shared service solution; a development component configured to develop service components for each of the set of candidate SOA shared services of the SOA shared service solution; and a deployment component configured to deploy at least one of the set of candidate SOA shared services of the SOA shared services solution.

### FIELD OF THE INVENTION

This invention relates generally to lifecycle management and more specifically to the lifecycle management of service oriented architecture shared services.

### BACKGROUND OF THE INVENTION

In the past, software architectures have attempted to deal with increasing levels of software complexity. As the level of complexity continues to increase, traditional architectures are reaching the limit of their ability to deal with various problems. At the same time, traditional needs of information technology (IT) organizations persist. IT organizations need to respond quickly to new requirements of the business, while continuing to reduce the cost of IT to the business by absorbing and integrating new business partners, new business sets, etc.

Adoption of Service Oriented Architectures (SOA) requires changes within an enterprise that go beyond technology and IT aspects only. SOA has a significant impact on the various processes and methodologies not only from an IT point-of-view, but also from a business perspective. SOA requires that the associated processes and methodologies include organizational processes, like business project planning, portfolio planning and management, aligning IT processes with changes in business goals and objectives, and many other organizational aspects. In order to enable such transformational initiatives, and more importantly, enable a model capable of sustaining change, it is essential to understand, define, document and roll-out an end-to-end lifecycle management process and methodology for the management of Services for an SOA enabled enterprise.

### SUMMARY OF THE INVENTION

In one embodiment, there is a method for managing a service oriented architecture (SOA) lifecycle. In this embodiment, the method comprises: identifying a set of business objectives, evaluating a need for a SOA service solution based on the set of business objectives; identifying a set of candidate SOA shared services of the SOA share service solution; developing service components for each of the set of candidate SOA shared services of the SOA shared service solution; and deploying at least one of the set of candidate SOA shared services of the SOA shared services solution.

In a second embodiment, there is a system for managing a service oriented architecture (SOA) lifecycle. In this embodiment, the system comprises at least one processing unit, and memory operably associated with the at least one processing unit. A lifecycle management tool is storable in memory and executable by the at least one processing unit. The lifecycle management tool comprises: an identification component configured to identify a set of business objectives, evaluate a need for a SOA service solution based on the set of business objectives, and identify a set of candidate SOA shared services of the SOA share service solution; a development component configured to develop service components for each of the set of candidate SOA shared services of the SOA shared service solution; and a deployment component configured to deploy at least one of the set of candidate SOA shared services of the SOA shared services solution.

In a third embodiment, there is a computer-readable medium storing computer instructions, which when executed, enables a computer system to manage a service oriented architecture (SOA) lifecycle, the computer instructions comprising: identifying a set of business objectives, evaluating a need for a SOA service solution based on the set of business objectives; identifying a set of candidate SOA shared services of the SOA share service solution; developing service components for each of the set of candidate SOA shared services of the SOA shared service solution; and deploying at least one of the set of candidate SOA shared services of the SOA shared services solution.

In a fourth embodiment, there is a method for deploying a lifecycle management tool for use in a computer system that provides management of a service oriented architecture (SOA) lifecycle. In this embodiment, a computer infrastructure is provided and is operable to: identify a set of business objectives, evaluate a need for a SOA service solution based on the set of business objectives; identify a set of candidate SOA shared services of the SOA share service solution; develop service components for each of the set of candidate SOA shared services of the SOA shared service solution; and deploy at least one of the set of candidate SOA shared services of the SOA shared services solution.

### BRIEF DESCRIPTION OF THE DRAWINGS

FIG. 1 shows a schematic of an exemplary computing environment in which elements of the present invention may operate;

FIG. 2 shows a lifecycle management tool that operates in the environment shown in FIG. 1; and

FIG. 3 shows a flow diagram of a method for managing a SOA lifecycle according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to managing a service oriented architecture (SOA) lifecycle. In these embodiments, a lifecycle management tool provides this capability. Specifically, the lifecycle management tool comprises an identification component configured to identify a set of business objectives, evaluate a need for a SOA service solution based on the set of business objectives, and identify a set of candidate SOA shared services of the SOA share service solution; a development component configured to develop service components for each of the set of candidate SOA shared services of the SOA shared service solution; and a deployment component configured to deploy at least one of the set of candidate SOA shared services of the SOA shared services solution.

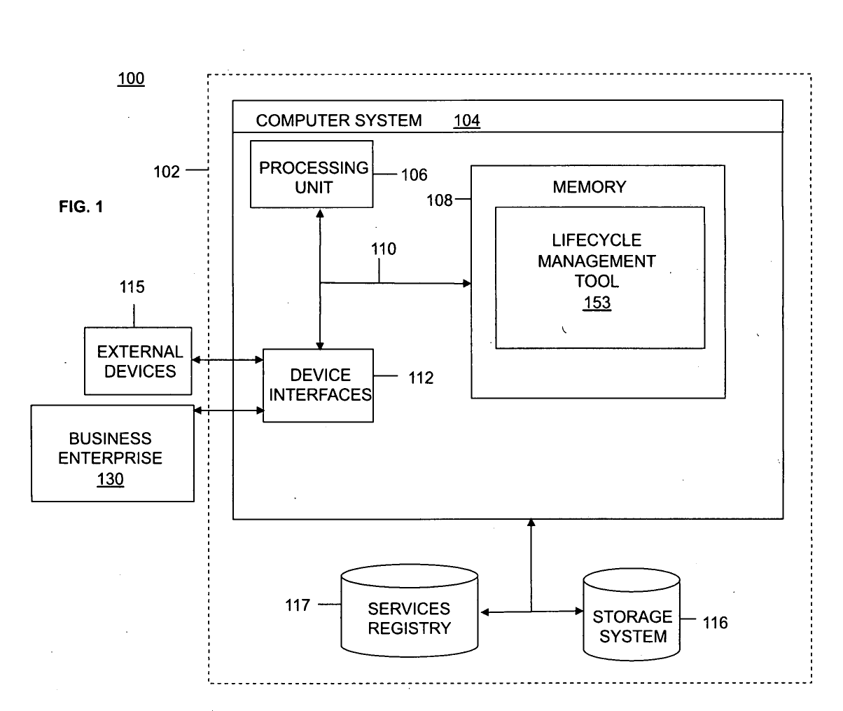

FIG. 1 illustrates a computerized SOA shared service solution 100 of the present invention. As depicted, SOA shared service solution 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of SOA shared service solution 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for managing a SOA shared service. It should be understood that any other computers implemented under the present invention may have different components/software, but will perform similar functions. As shown, computer system 104 includes a processing unit 106, memory 108 for storing a lifecycle management tool 153, a bus 110, and device interfaces 112.

Processing unit 106 collects and routes signals representing outputs from external devices 115 (e.g., a keyboard, a pointing device, a display, a graphical user interface, etc.) to lifecycle management tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating lifecycle management tool 153, which is stored in memory 108 and/or storage system 116. While executing computer program code, processing unit 106 can read and/or write data to/from memory 108, storage system 116, and a SOA shared services registry 117. SOA shared services registry 117 stores a plurality of SOA shared services and associated metadata, as well as rules against which the metadata is compared to locate, update, and store SOA shared services from decomposed business architectures, as will be further described below. Storage system 116 and services registry 117 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

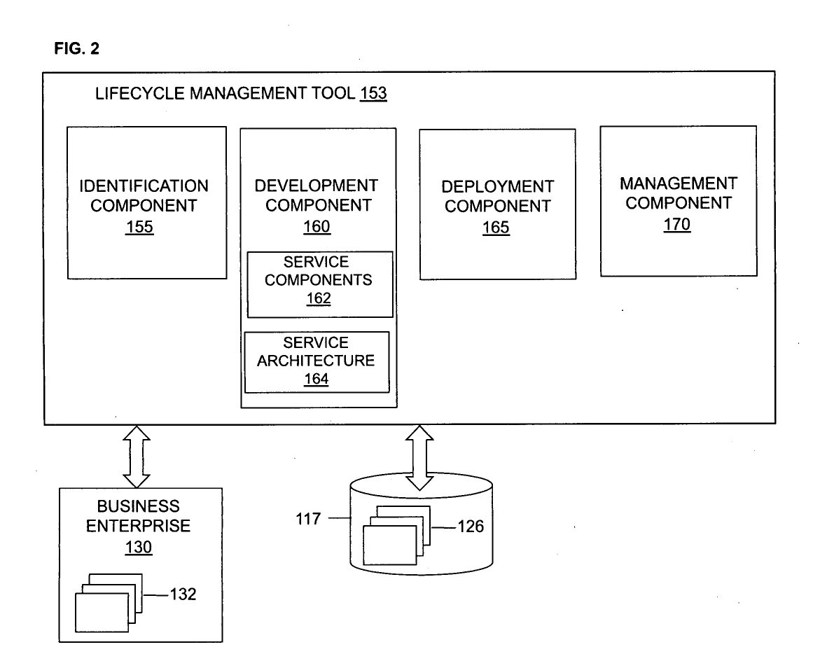

FIG. 2 shows a more detailed view of lifecycle management tool 153, which develops, defines, and rolls-out an end-to-end lifecycle management process in which identification of business services based on the business processes or the process components becomes a key aspect of the services lifecycle. As shown, lifecycle management tool 153 comprises an identification component 155 configured to identify a set of business objectives 132 (e.g., goals, benchmarks, etc.) of a business enterprise 130, and evaluate a need for a SOA service solution based on set of business objectives 132. The need for a SOA service solution may arise any time a business service is shared/consumed by multiple systems with the goal of flexibly adapting to business changes. Next, identification component 155 is configured to identify a set of candidate SOA shared services 126 of SOA shared service solution 100. In one embodiment, identification component 155 is configured to search within services registry 117 for existing SOA shared services that can be re-used. For example, the architectural, business, and system requirements of the SOA shared service solution are compared against the existing SOA shared services within services registry 117 to determine which candidate services meet the business need(s) the most. Furthermore, identification component 155 may inventory all other IT assets that are needed to support the set of candidate SOA shared services 126, and identify any other assets whose functionally can be re-used.

Once set of candidate SOA shared services 126 is identified, the individual service components for each service are developed. To accomplish this, a development component 160 is configured to develop service components 162 for each of set of candidate SOA shared services 126 of SOA shared service solution 100. Each of service components 162 is designed to be widely applicability to a large number of users/consumers. To accomplish this, the existing services are reviewed against the new requirements of SOA shared service solution 100, and enhancements/modifications are made to enable the current service(s) to meet the new requirements. Further, to maximize service integration, development component 160 is configured to develop a service architecture 164 (e.g., the hardware, software and the network systems, as well as configuration parameters required for each SOA shared service to become operational) to integrate set of candidate SOA shared services 126 of SOA shared service solution 100.

Next, service components 162 and service architecture 164 are tested and the SOA shared service(s) is deployed to production. To accomplish this, lifecycle management tool 153 comprises a deployment component 165 configured to deploy at least one of set of candidate SOA shared services 126 of SOA shared services solution 100. In one embodiment, deployment component 165 is configured to publish the at least one of set of candidate SOA shared services 126 of SOA shared services solution 100 to services registry 117 for future access/implementation.

After the SOA shared service is deployed, it is beneficial to manage/monitor the services to maintain continuing service offering and performance. In one embodiment, lifecycle management tool 153 comprises a management component 170 configured to manage the at least one of set of candidate SOA shared services 126 of SOA shared services solution 100. Specifically, management component 170 manages aspects of service configuration, service re-factoring, service evolution, and service phase-out that are essential for the governance and lifecycle management of SOA shared services. For example, management component 170 ensures that SOA shared services remain in the deployed state until at least one of the following events occurs: a request for a service modification (e.g., new version or development of a new service), the service does not function properly, the service will no longer be supported (e.g., service is to be disabled/retired.).

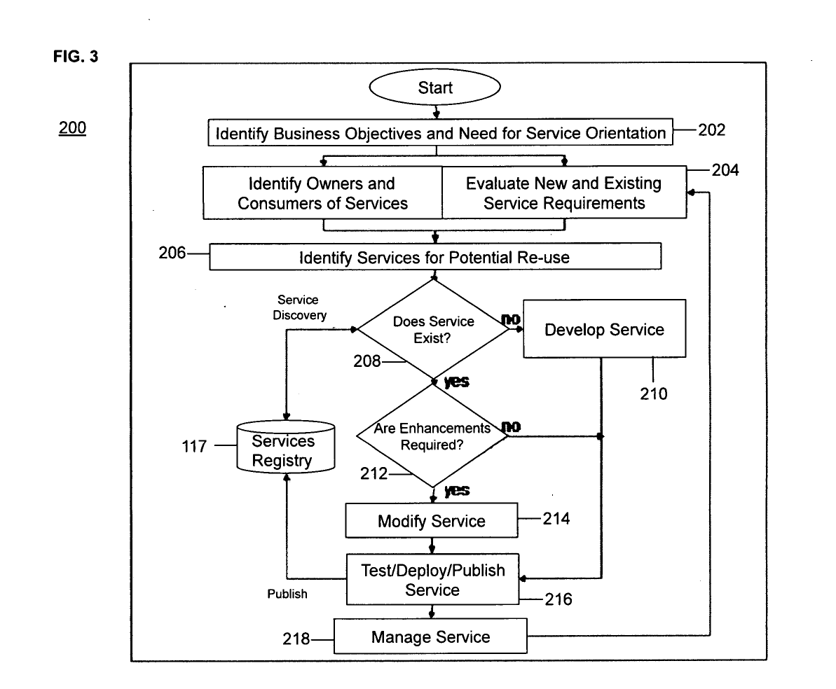

Referring now to FIG. 3, a lifecycle process 200 for managing a SOA lifecycle will be described in further detail. As shown, lifecycle process 200 begins at 202 by identifying the business objectives of a business enterprise and evaluating the need for a SOA service solution, which will address the business objectives. In this step, the overall program objectives and goals of the business enterprise are validated with high-level IT domain requirements. This may include performing executive level decisions to evaluate new and existing service requirements in terms of funding, prioritization, ownership of services, and their consumers (204). In this step, all the detailed requirements that would be used as input to develop services registry 117 are collected to address specific business objectives.

Next, at 206, lifecycle process 200 identifies candidate SOA shared services for potential re-use. At 208, it is determined whether the service exists. In one embodiment, services registry 117 is searched for existing services that can be re-used. If no service exists to meet the business objectives, the service is developed at 210. However, if a candidate service does exist, it is next determined at 212 whether enhancements or modifications are required to align the candidate service with the business objective(s). If yes, the service is modified at 214 by developing service components and a service architecture to integrate the candidate SOA shared service(s) with the SOA shared service solution. Next, at 216, the candidate service(s) is tested, deployed, and published to services registry 117 for subsequent use and/or re-use. Finally, at 218, the services are managed to maintain continuing service offering and performance.

It will be appreciated that lifecycle process 200 of FIG. 3 represents one possible implementation of a process flow for managing a SOA lifecycle, and that other process flows are possible within the scope of the invention. Lifecycle process 200 illustrates the architecture, functionality, and operation of possible implementations of systems, methods and computer program products according to various embodiments of the present invention. In this regard, each portion of the flowchart may represent a module, segment, or portion of code, which comprises one or more executable instructions for implementing the specified logical function(s). It will also be noted that each block of flowchart illustration can be implemented by special purpose hardware-based systems that perform the specified functions or acts, or combinations of special purpose hardware and computer instructions.

Further, it can be appreciated that the methodologies disclosed herein can be used within a computer system to provide management of a SOA lifecycle, as shown in FIG. 1. In this case, lifecycle management tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for managing a SOA lifecycle. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for managing a service oriented architecture (SOA) lifecycle comprising:
identifying a set of business objectives;
evaluating a need for a SOA service solution based on the set of business objectives;
identifying a set of candidate SOA shared services of the SOA shared service solution;
developing service components for each of the set of candidate SOA shared services of the SOA shared service solution; and
deploying at least one of the set of candidate SOA shared services of the SOA shared services solution.

2. The method according to claim 1 further comprising managing the at least one of the set of candidate SOA shared services of the SOA shared services solution.

3. The method according to claim 1, the identifying a set of candidate SOA shared services comprising searching within a services registry for existing SOA shared services that can be re-used.

4. The method according to claim 1, further comprising developing a service architecture to integrate the set of candidate SOA shared services of the SOA shared service solution.

5. The method according to claim 3, the deploying comprising publishing the at least one of the set of candidate SOA shared services of the SOA shared services solution to the services registry.

6. A system for managing a service oriented architecture (SOA) lifecycle comprising:
at least one processing unit;
memory operably associated with the at least one processing unit; and
a lifecycle management tool storable in memory and executable by the at least one processing unit, the lifecycle management tool comprising:
an identification component configured to:
identify a set of business objectives;
evaluate a need for a SOA service solution based on the set of business objectives; and
identify a set of candidate SOA shared services of the SOA shared service solution;
a development component configured to develop service components for each of the set of candidate SOA shared services of the SOA shared service solution; and
a deployment component configured to deploy at least one of the set of candidate SOA shared services of the SOA shared services solution.

7. The lifecycle management tool according to claim 6, further comprising a management component configured to manage the at least one of the set of candidate SOA shared services of the SOA shared services solution.

8. The lifecycle management tool according to claim 6, the identification component further configured to search within a services registry for existing SOA shared services that can be re-used.

9. The lifecycle management tool according to claim 6, the development component further configured to develop a service architecture to integrate the set of candidate SOA shared services of the SOA shared service solution.

10. The lifecycle management tool according to claim 8, the deployment component further configured to publish the at least one of the set of candidate SOA shared services of the SOA shared services solution to the services registry.

11. A computer-readable medium storing computer instructions, which when executed, enables a computer system to manage a service oriented architecture (SOA) lifecycle, the computer instructions comprising:
identifying a set of business objectives;
evaluating a need for a SOA service solution based on the set of business objectives;
identifying a set of candidate SOA shared services of the SOA shared service solution;
developing service components for each of the set of candidate SOA shared services of the SOA shared service solution; and
deploying at least one of the set of candidate SOA shared services of the SOA shared services solution.

12. The computer-readable medium according to claim 11, the computer instructions further comprising managing the at least one of the set of candidate SOA shared services of the SOA shared services solution.

13. The computer-readable medium according to claim 11, the computer instructions for identifying a set of candidate SOA shared services further comprising searching within a services registry for existing SOA shared services that can be re-used.

14. The computer-readable medium according to claim 11, the computer instructions further comprising developing a service architecture to integrate the set of candidate SOA shared services of the SOA shared service solution.

15. The computer readable medium according to claim 13, the computer instructions for deploying further comprising publishing the at least one of the set of candidate SOA shared services of the SOA shared services solution to the services registry.

16. A method for deploying a lifecycle management tool for use in a computer system that provides management of a service oriented architecture (SOA) lifecycle, comprising:
providing a computer infrastructure operable to:
identify a set of business objectives;
evaluate a need for a SOA service solution based on the set of business objectives;
identify a set of candidate SOA shared services of the SOA shared service solution;
develop service components for each of the set of candidate SOA shared services of the SOA shared service solution; and
deploy at least one of the set of candidate SOA shared services of the SOA shared services solution.

17. The method according to claim 16, the computer infrastructure further operable to manage the at least one of the set of candidate SOA shared services of the SOA shared services solution.

18. The method according to claim 16, the computer infrastructure operable to identify a set of candidate SOA shared services further operable to search within a services registry for existing SOA shared services that can be re-used.

19. The method according to claim 16, the computer infrastructure further operable to develop a service architecture to integrate the set of candidate SOA shared services of the SOA shared service solution.

20. The method according to claim 18, the computer infrastructure operable to deploy further operable to publish the at least one of the set of candidate SOA shared services of the SOA shared services solution to the services registry.
